(19) United States
(12) Patent Application Publication
(10) Pub. No.: US 2008/0028473 A1
(43) Pub. Date: Jan. 31, 2008

(54) Method of retaining and accessing receipt of purchase

(76) Inventor: Thomas G. Cehelnik, Tucson, AZ (US)

Correspondence Address: THOMAS G. CEHELNIK, 8300 E. OCOTILLO DR., TUCSON, AZ, 85750, US

(21) Appl. No.: 11/495,048

(22) Filed: Jul. 28, 2006

(51) Int. Cl. H04L 9/32; G06F 12/14; G06F 17/30; G06F 7/04; H04L 9/00; G06F 11/30; G06K 9/00; H04K 1/00; H03M 1/68; H04N 7/16

(52) U.S. Cl. 726/27; 713/193; 705/51; 705/52; 705/53

(57) ABSTRACT

A method of storing and receipt of purchase is described allowing convenient access and proof of purchase. The method is applicable to transfer of images, video streams, and movies. A scrambling and method of inaccessibility is claimed to reduce possibility of illegal copies. In addition to a paper copy, an image of the receipt is sent to a website from the point of purchase. The user of the service then has access to tools that allow sorting and monitoring of expenditures, access to special promotions from the stores they frequent, and a certified method of proof of purchase, and return or exchange status, and warranty registration, and warranty insurance. This method of receipt processing allows customers peace of mind by providing convenient access to receipt information even if the paper receipt is lost.

### CROSS REFERENCE TO RELATED APPLICATIONS

This application is to receive benefit of provisional application 60/586350 filed Jul. 7, 2004, and a provisional application having US Express Mail number 999958276, mailed Jul. 29, 2005, and having a corresponding application number.

### STATEMENT OF FEDERALLY SPONSORED RESEARCH OR DEVELOPMENT

Not applicable

### REFERENCE SEQUENCE LISTING OR COMPUTER PROGRAM

Not applicable

### SUMMARY OF THE INVENTION

This invention relates to an apparatus and method for distributing receipt of purchase.

### BACKGROUND OF THE INVENTION

The popularity of Internet banking reduces paperwork and improves accessibility associated with statements; but has not fully addressed the receipt process at the point of sale. This invention does so, by providing a method to make paperless receipt. A novelty of the invention is it addresses the need to reduce the likelihood of customers loosing money because of lost receipts required for returns, warranty repairs, and accounting needs.

Thus one aspect of the invention is to provide a method offering a means for storing and certifying data appearing on a paper cash register receipt.

Another aspect of this invention claimed is a service using the disclosed method in this invention that provides customer access to their receipts via the Internet and other data means.

Another aspect of this invention is to provide the purchaser of goods a method of providing credible receipt information to the retailer to allow for returns and credits of purchased merchandise.

Another aspect of this invention is it reduces the likelihood of fraudulent return and exchange of goods that were not purchased.

Another aspect of this invention is to include an option for a security encryption method of receipt data.

### BRIEF DESCRIPTION OF DRAWINGS

N/A—Material is self explanatory, but specification content can be shown in flow charts if required.

### DESCRIPTION OF THE PREFERRED EMBODIMENT

To those skilled in the art of information technology will recognize many variations in data management and accessibility; but nevertheless this invention includes such variations.

Cash register receipts provide a paper trail that is easily lost or discarded because of the cumbersome stuffing of the receipts into purchaser's wallets or purses.

The disclosed method reveals a process for scanning or electronically reproducing the line items from a receipt to a database. A receipt service provider referred herein as RSP that manages the database and access to it. The RSP hosts a website, like www.geturreceipt.com, or other appropriate name.

In the preferred embodiment, a means for importing the receipt text data is to use digital scanners or photography equipment or direct data file access from the cash register to provide an image of the receipt. The data is then transferred to the RSP via the Internet. A modem connection similar to those used to approve credit card transactions will allow the transfer via e-mail or internet protocol. Any data transfer method consistent with the technology progression will do.

The use of data or image encryption upon transferring the image is claimed. In particular with offer a key-code that is randomly generated prior to the transfer of the receipt image or text. This key is used to construct a scrambled image of the receipt or text data. One method is to compute the two-dimensional Fast Fourier transform FFT2 (2-dimensions) or suitable mathematical transform like cosine, and adjust the phase of each pixel in a way according to the said key-code. This is done by multiplying the FFT2 result by a phase exp(j*2*pi*phase), where the phase is compute as a random number for each pixel having number between −1 and 1. Other ranges of limits exist, but the method is understood from this discussion. Next the scrambled image of the receipt is obtained by an inverse FFT2 and then taking the real part. It is this scrambled image that is sent via the Internet. Thus without having the exact key sequence it becomes extremely difficult to practically impossible to construct the image. The key-code is give for each pixel; but can be generated by a digital filter like a FIR filter or autoregressive method, AR common in signal processing methods.

To view the image the scrambled code image a calculation is performed to remove intentional phase used to scramble the image. The FFT2 is computed from the scrambled image, and the result is multiplied by exp(−j*2*pi*phase), followed by the inverse FFT2 and the process of taking the real part. Of course the phase must be computed from the reception of the key-code that is e-mailed or transferred to the RSP and the user's e-mail account separately from the transfer of the scrambled image. The image reconstruction is done on the user's computer when viewing their information from the RSP website. Thus the use only downloads the image. The image reconstruction and coordination of association of key-codes with images is done by a software provided by the RSP.

The key-codes association with each image is made by a file stored on the RSP server. This file is downloaded to the user's computer and used in the reconstruction of the image. Note, the key-code is needed to see the image, since it is stored on the RSP server in scrambled form. For the retailer to see the receipts from its store, it needs to have the key-code corresponding to images that have the store's ID code, and User's Account code. This is done by having the key code sent during the receipt transfer to another server or equivalently isolated and protected storage area of the RSP. When the user enters their pin at the cashier of the retailer transfer occurs. To view receipt at the retailer, the retailer fetches the key-code corresponding to the store's ID and User's Account Code, along with the corresponding scrambled images, and reconstructs the receipt images. If the receipts are modified by the retailer, the updated receipt is sent to the RSP as described.

If a data formatting service is requested, then the RSP will construct the images as needed to offer encoded downloads. Also, the RSP may make checks on the data integrity, and RSP system status and compliance as needed by reconstructing random images on the system. To help reduce the need to look at customers data, regular tests with fake data can be automated between the Retailers and the RSP to confirm transfer operation.

It is also noted as claimed that this image reconstruction method is applicable to video and movie downloads. The movie will be made available from download with each frame scrambled as described, or in similar mean using other mathematical transformations. The movie service provider will then download the key-code for each frame. The computer or TV will then reconstruct the image at each frame. If a computational delay exists, then a hard-drive can be used to buffer the data for even flow. Each time the movie is downloaded in scramble from to a purchaser of the movie, sequence of key-codes is created for the purchase. This process reduces the likelihood of illegal copies of movies being passed over the Internet, since the key-code is generated for each download. During the reconstruction, the key-code can be deleted. To be sure key-codes are not copied illegally, the image processing software on the computer or TV will authorize the use of the decoder. It does this by connecting back to the movie sales website, verifying the key-code, and assuring it is paid for. This is like being sure the merchandise was indeed purchased. If the key code is used more than once by a different user the authorization fails. If it is used by the same user, identified by the RSP User Identification Code, then a request to pay via credit card is issued. If the credit card transaction fails the authorization to the users image processing software fails, and not movie is played. If all checks out the RSP sends a recognized code, such as a software license key to customers computer that allows the process of descrambling the images or video and makes playable on the machine. Upon playing the digital video, the digital form is made inaccessible by erasing or re-scrambling or encoding hereby called a means of inaccessibility in our claims. Thus the image reconstruction or descrambling processing is done on the fly or within a buffer. Thus the whole movie is never kept on disk or in a digital format capable of being viewed with standard viewing software or easily transferred. The only way to view the movie is to have an authorized; i.e. paid for, key-code and the descrambled video, and the RSP processor software that is available only in machine code so as not to easily be reconstructed. Also the RSP processor software can be modified and update as much as possible, since the new RSP processing software is made available when a valid key-code and its corresponding scrambled video.

Thus we see from our discussion in this specification, that this invention and in our claims we refer to RSP as not just a transfer of a cashier's receipt; but do so in the sense of authorizing image transfers that are in some scrambled or otherwise encoded format. Thus in this specification we are describing a process of transferring and retaining proof of receipt of purchase that included the exchange of images and pictures and or corresponding text on those images. The claims also apply to the purchase and transfer of snap shot pictures or still images as well as movies. A photograph or image of a receipt of sale from a cash register is a snap shot or still picture. Any text on a receipt such as authorization number etc., store number, can be added to the a photograph, still picture, or movie as needed and the methods described in this specification apply a reasoned to the transfer of movies and pictures as well as cash register receipts. Also, the sale of video games that play as video streams, or other video streams from the internet requiring payment follows the same method as described and are also claimed as media types under the generic term Receipt. To those in the art, other details can be changed by the process of confirmation of receipt and transferring an image or video using a key code applies and is covered.

Note it is possible to transfer just a picture of the receipt in bitmap, or JPEG format or other suitable code, or alternatively a text transmission with format information of the retails receipt form can be passed. Either way, the data items on the receipt can be sorted from the image stored of the receipt, or text format at the RSP server data base.

During the sale the retailer provides a retail authorization number. This code is printed on and associated with the receipt. The retail authorization number is related to the store number and transaction number being generated from the cash register computer network. It may include a time stamp to assist with uniqueness. The code is sent along with the receipt text data packet to the said database.

The user and retailers both sign up and agree to legal terms of using the RSP. Provisions in the legal contract between users and customers should include that the users will not use the system for fraudulent or otherwise illegal activity, and that their signature is authorized by using their pin, and a disclaimer about that the RSP attempts to keep the a secure system within reason and it is the responsibility of the customer to protect their account access from unauthorized users by not sharing the access codes or PIN.

Both the store and the purchaser benefit from the use of a RSP. The store receives purchase information for marketing and advertising, in similar fashion as grocery stores offer their discount savings cards. The user receives the piece of mind of knowing that the receipts are saved in case there is a return. Both benefit because the paper work is reduced and essentially made paperless. A paper receipt printout option exists.

The RSP has a registration number for each retailer. The RSP manages the database, and provides for Internet online access of information. The retailers provide promotional sales and advertisement to the RSP for posting associated with their retailer number. When the users access their receipt data, they will also have access to promotional sales advertising in the store they frequent. Tools are provided by the RSP to manage the accounts and store receipts. The receipt data can be itemized and logged as a budgeting and accounting. Also, manufacture coupons are also advertised on the website. Accounting software and bank management software are easily specialized to aid in generating reports from down loads. The RSP may also offer Web & e-mail orders for products, and delivery of goods, by providing links to the store for shopping.

The user receives a disclosure of the service, and signs up to receive a user computer account, and a web address to a secure site that allows access to their data via password protection. The customer also receives an account number and contact phone number and website information that allows the cash register attendant /retailer to dial or connect their cash register receipt system to the customers RSP. The connection is established by the retailer to provide opportunity for customer to verify and authorize their connection to the RSP website via Pin or password, or biometric data input at the cashiers station.

In the preferred embodiment the customer receives a RSP card for storing the RSP contact information, and customer account number. This can be on a magnetic strip, or smart card, that has their user receipt code embossed on it. The retailer scans the card, and asks for a user code or Personal Identification Number, PIN, or other secure method of login into the RSP. Upon this verification with the RSP, the transfer of receipt information occurs through the internet to the RSP database under the customer's account. This receipt verification process can take place at the same time as a credit card transaction. When the system is accepted by major credit card companies, the connection information for the customer's RSP can be made available on the credit card. It is conceivable that the major credit card companies may become RSP servers. This invention claims a novel and useful method of service as a RSP and the claims are not dependent upon the specific company that implements the method.

The RSP card can also serve multiple purposes, such as a check-cashing card, and discount card, or club membership card. Today, most retailers, and grocery stores, etc., have their own card that may or may not be a credit card. This approach actually becomes not useful because people do not conveniently carry so many cards. A useful feature of this invention is the fact that it is a single card, as opposed to many cards for customer are so familiar with. Thus it is good for authorizing receipt service data transaction to the RSP.

During the sale process, a retailer code, and transaction code is associated with the type of transaction purchase, return, or exchange. The information on the cash register receipt is transmitted to the user's RSP after authorization from the user. Included in the data packet are the user's RPS account number. The RSP receives the data and updates the user's data in the database.

The stores accept original sale receipts by its usual methods; but encourage their customers to use an RSP for everyone's protection. For cash returns there is no guarantee that the customer has their own receipt and not another. For credit card refunds or exchanges the credit card is requested and compared with partial numbers. In fact, the bar code on the receipt often allows the refund to be processed without the card. Hence, cash and sometimes credit transactions are not protected from fraudulent returns or exchanges unless an item specific monitoring system as claimed in this invention is used.

Customers using a RSP, help prevent people from returning stolen merchandise with someone's receipt, or without one. The use of RSP would protect customers, by always allowing cash refunds within the acceptable time frame because they would have the receipt. This saves the customer money, and prevents fraud.

In the event when an original register generated receipt is presented, the customer is asked if they have joined receipt service certification service. Since the retailer receives benefits by using the service, it recommends the customer signup to one of its preferred RSP. IDs should be checked when presenting a receipt. The retailer can also have their own account to transmit the records to record their necessary information about those and products returned without the RSP.

The invented receipt processing method provides certification of customer transactions by contacting the RSP for validation of a receipt and authorization for any return service. The validation occurs when the customer provides their RSP card and authorizes access to their account on the receipt service database access.

In the case where a hard copy of the receipt is required, the customer accesses their receipt images via the Web by logging in. RSP cards reader machines are made available in the store for this purpose also. This customer is then provided a validation number when downloading an official printable copy of the receipt. When this is shown to the store clerk, the number is verified by computer connection or a phone call using touch-tone or voice command. The receipt line item and a corresponding record containing store code, UPIC code, price, and item description, is also keyed in or scanned. The RSP searches its data files under the users account, and the validation number. If a match occurs between the item and the validation number, and a valid transaction is permitted, the retailer is given authorization for the transaction. This is the RSP has certified that the item record was indeed purchased, is within return period, or warranty period, and has not previously been returned for refund. Other criteria exist and are easily expounded upon what is already stated. To get specific store requirements or refunds, returns, etc. from receipts, the RSP gets the stores input from the retailer regarding the retailer policies. Upon authorization for the requested transaction, the retailer performs the transaction. The new transaction is communicated to the RSP after the complete the transaction to update the RSP records.

The RSP updates the records according to the command issued by the clerk. This is done by phone or terminal connection, with commands such as return, exchange, or change. The old data record is modified after matching the purchase confirmation number, user RSP account, users RSP PIN, and the retailer ID, and Retailer pass code. Multiple authorized downloads are for proof-of-purchase only. Nonofficial copies are available anytime for personal accounting use. Multiple requests for validated receipts are monitored, and kept valid for a set period of time. Data is monitored by the RSP to prevent invalid and suspicious activities, such as multiple returns for credit of the same item from multiple validated receipts.

Another feature is gift vouchers and certificates can be sent to the receipt-processing center representative of the retailer. This can be achieved by an Internet link from the store web page. The person receiving the gift gets notification by e-mail, an auto-phone message, and a written letter after a prescribed amount of time. The sender also decides how to notify the recipient of the gift. The recipient goes to the retail store, either by Website or in person to a store. An exchange of merchandise is performed with the method described above; but instead the recipient of the gift must verify the sender's name or RCS account number. This is done after confirmed the gift authorization certificate number and the name and ID of the recipient.

1. A method allowing the automated accessing of receipts of purchase, or images, photographs, still pictures, movies, or games having:
a. A membership services for accessing web interface with a Receipt of Service Provider allowing user to have a PIN to authorize access and receipt of services;
b. Receipt of key-code upon purchase used to descramble images;
c. Uses a software to reconstruct images or video using keycode;
d. Software having a means of inaccessibility by not storing the reconstructed image but in suitable buffers if needed thus eliminated the storage of a complete digital video stream, movie, or image called receipt of purchase;

2. A system as in claim 1:
a. Using a shopper card involving sign up between users and retailer to allow for market monitoring, promotions sales, and other specials such as gift cards;
b. Provides access of receipt of purchase from a store having a store ID and customer access with a PIN.
c. Allows retailer to update image record of receipt upon return of merchandise or exchange.
